(19) United States
(12) Patent Application Publication
(10) Pub. No.: US 2015/0241901 A1
(43) Pub. Date: Aug. 27, 2015

(54) POWER SUPPLY CONTROL DEVICE

(71) Applicant: FREESCALE SEMICONDUCTOR, INC., Austin, TX (US)

(72) Inventors: Kamel Abouda, Saint Lys (FR); Estelle Huynh, Toulouse (FR); Thierry Laplagne, Cugnaux (FR)

(73) Assignee: Freescale Semiconductor, Inc., Austin, TX (US)

(21) Appl. No.: 14/431,790

(22) PCT Filed: Sep. 27, 2012
(86) PCT No.: PCT/IB2012/002224

§ 371 Date: Mar. 27, 2015

(51) Int. Cl. G05F 3/08; H02J 1/00; H02M 3/158

(52) U.S. Cl. CPC G05F 3/08; H02M 3/158; H02J 1/00

(57) ABSTRACT

An electronic device is for controlling multiple switching power circuits in a power supply system. Each switching power circuit has a power clock for controlling switching of a supply side switch that enables charging. The device has respective power clock delay units. Each respective power clock delay unit provides a respective power clock at a predetermined delay based on a respective input clock. The respective predetermined delays are chosen so that said switching of respective different supply side switches occurs at respective different points in time. Advantageously the conducted emission in high frequency bands is reduced.

### FIELD OF THE INVENTION

The invention relates to an electronic device for controlling multiple switching power circuits in a power supply system.

### BACKGROUND OF THE INVENTION

U.S. Pat. No. 8,120,205 describes a distributed power management system. The system may include a digital communication bus and a plurality of point-of-load (POL) regulators coupled to the communication bus. For example, a POL regulator may be a switching power regulator that switches a pair of power transistors, usually called high-side switch and low side switch, for producing a square wave, followed by an inductance and capacitance forming an LC circuit for smoothing out the output voltage to the load. The POL regulators are configured in a supply current sharing arrangement in which each POL regulator has a respective output stage and is configured to generate a respective output current. Each POL regulator may be controlled via a respective phase of a clock signal, and each POL regulator may transmit and receive information over the bus according to a bus communication protocol corresponding to the bus. Each POL regulator may autonomously add and drop its phase as required by the system, by sequentially manipulating a pulse width of a couple of gate signals configured to respectively control the high-side field effect transistor (FET) and low-side FET in the POL regulators output stage.

Such power switching circuits switch relatively large currents, causing large transient voltage variations on the power supply lines. Hence operating the power switches may generate power line noise.

The above US patent describes that DC voltage is typically stepped down in one of two ways, linear regulation and DC-to-DC conversion. DC-to-DC converters may step down DC voltage by pulse width modulation (PWM) of an input voltage and passive filtering of the output. The duty cycle of the PWM signal generally approximates the ratio of output voltage to input voltage divided by the efficiency of the converter. For example, for a 100% efficient DC-to-DC converter with a desired output of 1.2V and an input of 12V, the duty cycle would be 10%. In high current applications, the various DC-to-DC converters may be forced to use different “phases” of a common clock cycle, switching on the high side switch usually called charging, and using subsequent phases called staggered phase. To prevent DC-to-DC converters in a system from all charging in the first 10% of a clock cycle, one converter may charge during the first 10% of the clock cycle and the next converter may charge during a different 10% of the clock cycle, and so on. This typically reduces noise and improves transient response. This technique is also used in motor control and may, for example, be implemented to control multiple fans in a system. PWM controlled fans with staggered phase typically offer reduced acoustic noise.

In the above power control system, the staggered phases are based on a main clock that is used to subsequently activate respective POL regulators to charge. A problem of such power switching control is that power line noise causes unwanted conducted, and possibly transmitted, emissions.

### SUMMARY OF THE INVENTION

The present invention provides an electronic device, and a method, as described in the accompanying claims.

Specific embodiments of the invention are set forth in the dependent claims. Aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings.

FIG. 1 shows an example of an electronic device for controlling multiple switching power circuits in a power supply system,

FIG. 2a shows a delay unit for an electronic device for controlling multiple switching power circuits,

FIG. 2b shows a basic delay unit for an electronic device for controlling multiple switching power circuits,

FIG. 2c shows delay dependency of a delay circuit,

FIG. 3 shows a noise on a supply line with and without delay units, and

FIG. 4 shows a noise spectrum with and without delay units.

Elements in the figures are illustrated for simplicity and clarity and have not necessarily been drawn to scale. In the Figures, elements which correspond to elements already described may have the same reference numerals.

### DETAILED DESCRIPTION OF THE PREFERRED EMBODIMENTS

In distributed power control systems, when using multiple high side switches for multiple power switching circuits, multiple control circuits are needed to drive those switches. However, charge pump circuits are noisy analog circuits causing conducted, and possible transmitted, emissions. If all switches are turned ON at the same time, this will conduct huge noise to a power supply line, e.g. a battery line, which means conducted emission on battery line will be out of the required specification. The architecture described now allows to drastically reduce this noise.

For example, in an automotive environment, complexity of power control increases with the integration level of the various functions in integrated circuits (ICs). One power control IC can control many high side and low side switches used for controlling power units for various car functional units like injectors, lighting applications, automatic break system (ABS) and airbags. The proposed system controls multiple high side switches while avoiding an untimely turning ON resulting on huge current peaks during start up phases, as follows.

An electronic device is provided for controlling multiple switching power circuits in a power supply system. Each switching power circuit has a power clock for controlling switching of a supply side switch that enables charging. The device thereto has multiple power clock generators for generating the respective, different power clocks. Each respective power clock generator has a delay unit for generating a respective power clock based on a respective input clock at a predetermined delay, the respective predetermined delays being so that said switching of respective different supply side switches occurs at respective different points in time. Hence the current peak is well reduced resulting in spreading the spectrum which will drastically reduce the conducted emission on the power supply lines.

The power control system of U.S. Pat. No. 8,120,205 uses control of data inputs to achieve its staggered phases by a gate control circuit inside the high side driver itself for creating delays between buffers in order to reduce di/dt and peak current at a time. The current proposal delays the respective “turn on time” between different power switches by providing respective different delayed clocks, and does not act on the data but on clock signal only. In fact the method of staggered phases via data control and the current clock delaying method may be combined.

An analog cell delay may be used in the proposed circuit. The delay may be controlled by a control current or reference current, and then be more stable versus process and temperature variations, whereas traditional digital buffers used for delaying clock signals provide a delay that varies with both process and especially with temperature.

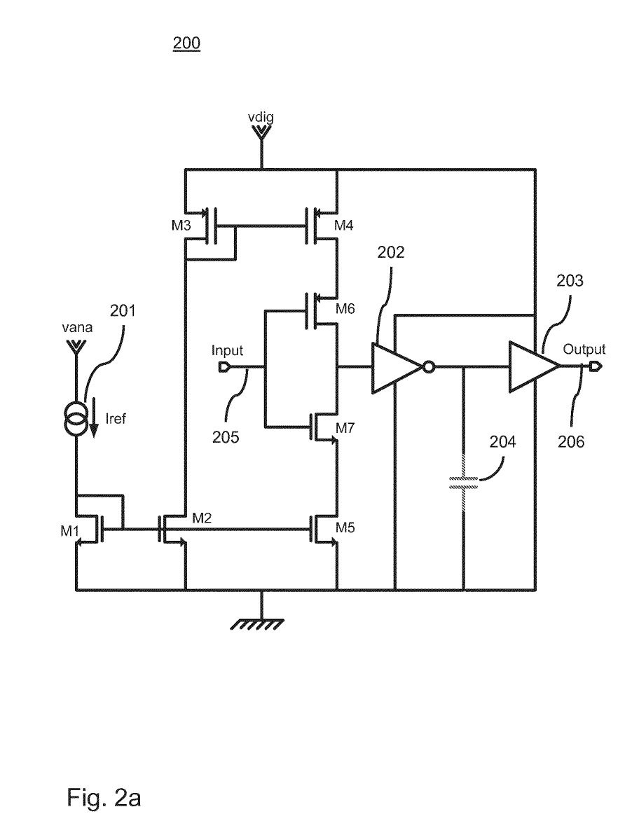

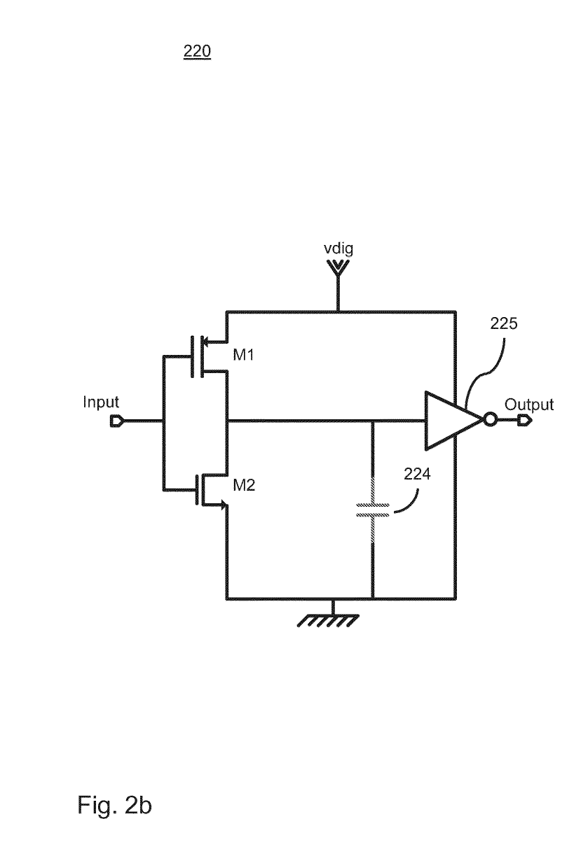

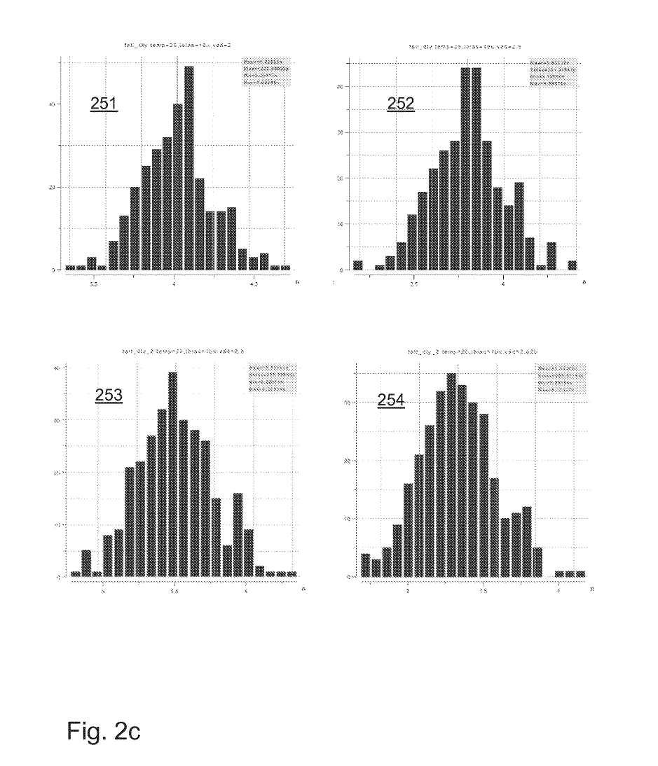

One possible analog technique will be charge and discharge of a capacitor, as shown in FIG. 2b in a basic delay cell as described later. A more accurate analog delay cell may regulate charge and discharge current of the capacitor depending on voltage across the capacitor, but this may require more analog delay circuitry and increase the die size for this feature. Optionally, the analog delay cell comprises a control current source for generating a control current for determining the predetermined delay. In FIG. 2a an accurate delay cell is shown having a control current source, as described below.

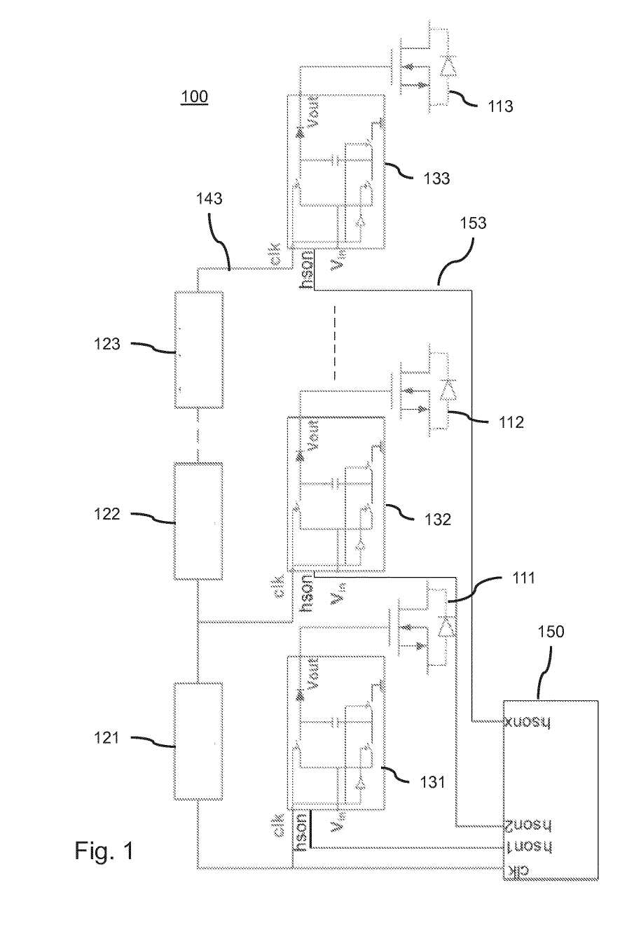

FIG. 1 shows an example of an electronic device for controlling multiple switching power circuits in a power supply system. The device 100 has multiple power switches 111,112,113 that are further connected to a supply power line (not shown) to act as a supply side switch that enables charging of a power unit such as a charge pump circuit. As such, charge pump circuits are well known as described in the introductory part, and may provide a required power supply to a circuit or device, e.g. in a car. The device further has multiple switching power circuits 131,132,133. The switching power circuit 133 has an input for receiving a power clock 143 for controlling switching of the respective supply side switch 113.

The device further has respective power clock delay units 121,122,123. The power clock delay unit 123 provides the respective power clock 143 at a predetermined delay based on a respective input clock. The respective predetermined delays of the respective delay units are dimensioned so that said switching of respective different supply side switches occurs at respective different points in time.

In the example the power clock delay units 121,122,123 coupled in series by connecting the input clock of a respective power clock delay unit to the power clock of the preceding power clock delay unit. Such a configuration may be called daisy chaining, i.e. daisy chaining of clock signals that drive multiple charge pump circuits which are known to be noisy. It is noted that the system can be used anywhere to avoid clock controlled switching of multiple power switches at the same time. Hence generating huge current peaks and failing conducted emission specifications is avoided.

Optionally one or more, or even all power clocks, may be provided by connecting the respective power clock delay units in parallel, and/or a first power clock may be a main clock provided from a clock generator without further delay. In the Figure, the first power switching circuit receives the main clock without any delay on its clock input.

In FIG. 1 the device has a digital control unit 150 for controlling said multiple switching power circuits. Each of the multiple switching power circuits may have a respective data input 143 for controlling the respective switching power circuit 133, whereas the digital control unit may have corresponding control output signals coupled to said respective data inputs. Alternatively such control output signals may be transferred to the respective switching power circuits via a communication bus, or by directly setting parameters in respective control registers of the switching power circuit.

In practice, a single device may include said multiple switching power circuits, or it may be a control unit only. Alternatively, the respective delay units and/or switching power circuits and power switches may be distributed across multiple devices, each device having one or more delay units and/or switching power circuits and power switches, and the devices being coupled via a communication interface to coordinate the respective delays, for example via a central control unit that sets or activates respective individual regulator devices. Alternatively such multiple individual regulator devices may have their respective power clocks externally daisy chained. Also, such devices may include said multiple supply side switches 111,112,113 coupled to said switching power circuits 131,132,133. Also, such devices may be constructed based on separate components, e.g. on a printed circuit board, or it may be embodied in an integrated circuit.

FIG. 2a shows a delay unit for an electronic device for controlling multiple switching power circuits. The electronic device has been described above with reference to FIG. 1. The delay unit 200 is an analog delay cell, which has a capacitor 204 that is charged and discharged via an inverter 202 receiving an input clock, while an output clock is provided by a further inverter 203.

The cell analog delay is based on controlling the pull up and pull down current of the first digital inverter 202 by means of a controlled current and switches M6, M7. The digital inverter 202 guides the controlled current to the capacitor 204. The controlled current is provided by a control current source including a reference current source 201 that generates Iref, and further current guiding and mirroring elements M1 to M5. The controlled current is coupled via M2 and M5 to the low side switch M7, and via M3 and M4 to the high side switch M6. Accurate control of pull up and pull down current by the control current source will effectively determine the switching delay from the input 205 to output 206 via the second inverter 203 during turn ON and turn OFF. The technique gives accurate delay (around 1 ns across process and supply variations), as the control is based on the reference current Iref by the current source 201, for example derived from an analog supply voltage Vana. The analog supply voltage is not affected by digital switching currents, and is therefore more stable.

FIG. 2b shows a basic delay unit for an electronic device for controlling multiple switching power circuits. The basic technique for providing controlled delay of a clock is based on control of current charge and discharge of a capacitor 224 by means of a high side switch M1 and a low side switch M2, followed by a buffer 225. Although the delay can be tuned for a specific process, the circuit may give variation of delay versus process and supply, especially regarding falling time delay (see results graphically depicted in FIG. 2c). It is noted that the structure 200 of FIG. 2a is more stable and accurate versus supply and process variation than the structure 220 of FIG. 2b, which is due to the added control current source circuit. In particular the most sensitive is fall delay.

The following statistical data have been determined for variation across process parameters, at multiple supply voltages Vdd, and based on 300 samples each. Delay times are defined in nanoseconds n (or picoseconds p). For the circuit 200 as shown in FIG. 2a, statistics of rise time and fall delay are as follows at a supply voltage Vdd=2,625 V:

Statistics of: rise_dly - Params: Temp = 25 Ibias = 10 u Vdd = 2.625

| | |
|---|---|
| Nominal: | 3.68270 n |
| Mean: | 3.69143 n +/−0.030 n (+/−0.82%) |
| Stdev: | 200.91377 p (182.604 p, 226.131 p) |
| Min: | 3.17243 n (Temp = 25 Ibias = 1e−05 Vdd = 2.625 |
| | stat_run = 284) |
| Max: | 4.38485 n (Temp = 25 Ibias = 1e−05 Vdd = 2.625 |
| | stat_run = 3) |
| Range: | 1.21242 n |

Statistics of: fall_dly - Params: Temp = 25 Ibias = 10 u Vdd = 2.625

| | |
|---|---|
| Nominal: | 3.74224 n |
| Mean: | 3.74444 n +/−0.030 n (+/−0.80%) |
| Stdev: | 199.93591 p (181.715 p, 225.031 p) |
| Min: | 3.13298 n (Temp = 25 Ibias = 1e−05 Vdd = 2.625 |
| | stat_run = 284) |
| Max: | 4.36337 n (Temp = 25 Ibias = 1e−05 Vdd = 2.625 |
| | stat_run = 61) |
| Range: | 1.23039 n |

For the circuit 220 as shown in FIG. 2b, statistics of rise time and fall delay are as follows at a supply voltage Vdd=2,625 V:

Statistics of: rise_dly_2 - Params: Temp = 25 Ibias = 10 u Vdd = 2.625

| | |
|---|---|
| Nominal: | 3.53833 n |
| Mean: | 3.54866 n +/−0.030 n (+/−0.84%) |
| Stdev: | 199.84820 p (181.635 p, 224.932 p) |
| Min: | 2.97965 n (Temp = 25 Ibias = 1e−05 Vdd = 2.625 |
| | stat_run = 284) |
| Max: | 4.18884 n (Temp = 25 Ibias = 1e−05 Vdd = 2.625 |
| | stat_run = 260) |
| Range: | 1.20919 n |

Statistics of: fall_dly_2 - Params: Temp = 25 Ibias = 10 u Vdd = 2.625

| | |
|---|---|
| Nominal: | 3.31434 n |
| Mean: | 3.33269 n +/−0.038 n (+/−1.2%) |
| Stdev: | 256.67765 p (233.286 p, 288.894 p) |
| Min: | 2.69264 n (Temp = 25 Ibias = 1e−05 Vdd = 2.625 |
| | stat_run = 117) |
| Max: | 4.12327 n (Temp = 25 Ibias = 1e−05 Vdd = 2.625 |
| | stat_run = 3) |
| Range: | 1.43063 n |

For the circuit 200 as shown in FIG. 2a, statistics of rise time and fall delay are as follows at a supply voltage Vdd=2.5 V.

Statistics of: rise_dly - Params: Temp = 25 Ibias = 10 u Vdd = 2.5

| | |
|---|---|
| Nominal: | 3.83038 n |
| Mean: | 3.83364 n +/−0.032 n (+/−0.84%) |
| Stdev: | 215.76114 p (196.098 p, 242.842 p) |
| Min: | 3.26545 n (Temp = 25 Ibias = 1e−05 Vdd = 2.5 stat_run = 284) |
| Max: | 4.56563 n (Temp = 25 Ibias = 1e−05 Vdd = 2.5 stat_run = 3) |
| Range: | 1.30018 n |

Statistics of: fall_dly - Params: Temp = 25 Ibias = 10 u Vdd = 2.5

| | |
|---|---|
| Nominal: | 3.81624 n |
| Mean: | 3.80238 n +/−0.030 n (+/−0.80%) |
| Stdev: | 201.91543 p (183.514 p, 227.259 p) |
| Min: | 3.19558 n (Temp = 25 Ibias = 1e−05 Vdd = 2.5 stat_run = 284) |
| Max: | 4.39875 n (Temp = 25 Ibias = 1e−05 Vdd = 2.5 stat_run = 61) |
| Range: | 1.20317 n |

For the circuit 220 as shown in FIG. 2b, statistics of rise time and fall delay are as follows at a supply voltage Vdd=2.5 V

Statistics of: rise_dly_2 - Params: Temp = 25 Ibias = 10 u Vdd = 2.5

| | |
|---|---|
| Nominal: | 3.60880 n |
| Mean: | 3.62117 n +/−0.031 n (+/−0.85%) |
| Stdev: | 205.34397 p (186.630 p, 231.118 p) |
| Min: | 3.04378 n (Temp = 25 Ibias = 1e−05 Vdd = 2.5 stat_run = 284) |
| Max: | 4.26964 n (Temp = 25 Ibias = 1e−05 Vdd = 2.5 stat_run = 260) |
| Range: | 1.22586 n |

Statistics of: fall_dly_2 - Params: Temp = 25 Ibias = 10 u Vdd = 2.5

| | |
|---|---|
| Nominal: | 3.49131 n |
| Mean: | 3.50981 n +/−0.041 n (+/−1.2%) |
| Stdev: | 272.16855 p (247.365 p, 306.330 p) |
| Min: | 2.82676 n (Temp = 25 Ibias = 1e−05 Vdd = 2.5 stat_run = 117) |
| Max: | 4.34425 n (Temp = 25 Ibias = 1e−05 Vdd = 2.5 stat_run = 3) |
| Range: | 1.51749 n |

For the circuit 200 as shown in FIG. 2a, statistics of rise time and fall delay are as follows at a supply voltage Vdd=2.0 V.

Statistics of: rise_dly - Params: Temp = 25 Ibias = 10 u Vdd = 2

| | |
|---|---|
| Nominal: | 4.86082 n |
| Mean: | 4.86751 n +/−0.047 n (+/−0.97%) |
| Stdev: | 315.78045 p (287.002 p, 355.416 p) |
| Min: | 4.03058 n (Temp = 25 Ibias = 1e−05 Vdd = 2 stat_run = 284) |
| Max: | 5.84530 n (Temp = 25 Ibias = 1e−05 Vdd = 2 stat_run = 3) |
| Range: | 1.81472 n |

Statistics of: fall_dly - Params: Temp = 25 Ibias = 10 u Vdd = 2

| | |
|---|---|
| Nominal: | 4.02091 n |
| Mean: | 4.02025 n +/−0.033 n (+/−0.83%) |
| Stdev: | 222.88022 p (202.568 p, 250.855 p) |
| Min: | 3.35417 n (Temp = 25 Ibias = 1e−05 Vdd = 2 stat_run = 284) |
| Max: | 4.69648 n (Temp = 25 Ibias = 1e−05 Vdd = 2 stat_run = 61) |
| Range: | 1.34232 n |

For the circuit 220 as shown in FIG. 2b, statistics of rise time and fall delay are as follows at a supply voltage Vdd=2.0 V

Statistics of: rise_dly_2 - Params: Temp = 25 Ibias = 10 u Vdd = 2

| | |
|---|---|
| Nominal: | 3.99548 n |
| Mean: | 4.00064 n +/−0.036 n (+/−0.89%) |
| Stdev: | 238.16927 p (216.464 p, 268.063 p) |
| Min: | 3.34826 n (Temp = 25 Ibias = 1e−05 Vdd = 2 stat_run = 191) |
| Max: | 4.68527 n (Temp = 25 Ibias = 1e−05 Vdd = 2 stat_run = 260) |
| Range: | 1.33700 n |

Statistics of: fall_dly_2 - Params: Temp = 25 Ibias = 10 u Vdd = 2

| | |
|---|---|
| Nominal: | 4.60644 n |
| Mean: | −4.67842 n +/−2.564 n (+/−54.8%) |
| Stdev: | 17.10713 n (15.548 n, 19.254 n) |
| Min: | −36.75761 n (Temp = 25 Ibias = 1e−05 Vdd = 2 stat_run = 180) |
| Max: | 4.90303 n (Temp = 25 Ibias = 1e−05 Vdd = 2 stat_run = 38) |
| Range: | 41.66064 n |

It is noted that the circuit 220 is not suitable for operation at a supply voltage of 2.0 V, because it often fails to switch.

FIG. 2c shows delay dependency of delay circuits. The Figure shows that the delay of the buffer unit is dependent on the variation of process and supply voltage. In the Figure graphs show the falling time delay in ns on the horizontal axis, versus process and supply variation on the vertical axis. The graphs correspond to the above mentioned statistical data. In the basic analog delay cell 220 as shown in FIG. 2b the dependency is reduced. In the accurate delay cell 200 as described above the dependency is further reduced.

The first graph 251 shows the fall delay at Vdd=2.0V of the accurate cell, and the second graph 252 shows the fall delay at Vdd=2.5V. The third graph 253 shows the fall delay at Vdd=2.5V of the basic cell, and the second graph 254 shows the fall delay at Vdd=2,625V.

Optionally, the control current of the control current source is predetermined during design of the device. The current may be set to a required value by adjusting the (W, L) parameters of the semiconductor elements in said current mirroring and sourcing circuit M1, M2, M3, M4 and M5.

Optionally, the control current of the control current source is adjustable via a control signal. For example, in the analog delay cell shown in FIG. 2a, the current source 201 may have a control input for adjusting the reference current. A control signal for such control input may be generated internally in the device by a delay control unit. Such a delay control unit may provide a number of control signals to be coupled to the respective multiple delay units.

Optionally, respective control currents of the control current sources for respective analog delay cells are programmable. The control signals may be generated internally in the device by a digital delay control unit. Such a delay control unit may have a programmable memory, e.g. based on fusible semiconductors or wires or EEPROM, and generates a number of control signals based on the values in said memory. The control signals are coupled to the respective multiple delay units.

Optionally, the device has a delay control input, e.g. an external pin or communication interface. Such interface may be based on an industry standard bus like 120 or any suitable serial or parallel data interface. The delay control input is coupled to a digital delay control unit. Such a delay control unit similar to the unit described above, which generates a number of control signals based on the input values from the delay control input. The control signals are coupled to the respective multiple delay units, whereby respective control currents for respective analog delay cells may be adjusted via the delay control input.

It is noted that the proposed power control architecture is different from the power control system discussed in U.S. Pat. No. 8,120,205 based on said staggered phases. First the staggered phases are generated by switching ON respective power switches depending on the main clock frequency. Hence the delay of a staggered phase can be very long which may not be acceptable for the application. On the contrary, in the current power control architecture the delay is determined by the respective predetermined delays of the delay units, and can be set as required by the application independent of the main clock frequency. Secondly, said staggered phases require a relatively high main clock frequency, e.g. ten times higher than the clock cycle switching frequency of the switching power regulators to enable subdividing the clock cycle in staggered phases of 10%. Such high main clock frequency may cause RF emissions, e.g. in the FM radio band. On the contrary, as the current architecture shifts the switching instants by the delay unit, the main clock frequency may be equal to the required switching clock cycle, and therefore is substantially lower. Moreover, when the required switching clock cycle is near the achievable main clock frequency the traditional system cannot be applied to create staggered phases. Finally, the control of the staggered multi phasing has to be performed at a system level, e.g. by a microcontroller, to avoid current sampling of regulators at same time. Hence additional software must be provided for such a control system, which increases development cost and time. Also, reducing emissions by extra decoupling capacitors on is not very effective and also increases cost.

The current power control architecture is different because its avoids turning ON of all high side switches at same by determining accurate delays by suitably shifting the respective power clocks by delay units obviating the limitations above. Furthermore, the architecture reduces the cost of application in a practical system requiring multiple power units, because it requires no external software or external components such as decoupling EMI capacitors. It also reduces the time of development, because there is no need of special software for multi phasing control signals. Finally, it reduces both conducted and radiated emission of the device in its application.

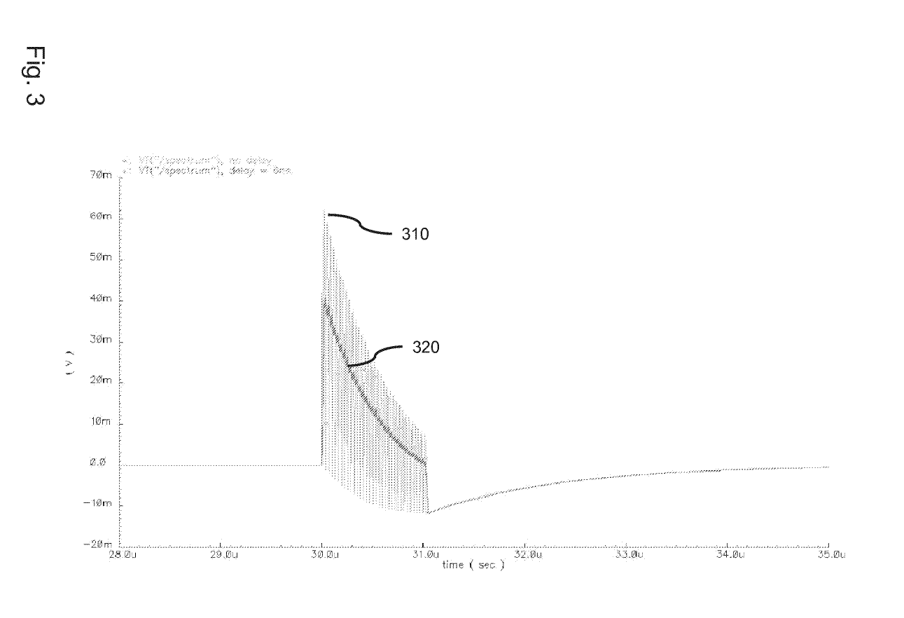

FIG. 3 shows a noise on a supply line with and without delay units. In the Figure a graph shows the deviation of the power supply voltage in mV on the vertical axis, versus time in microseconds (us) on the horizontal axis. In the example the delay units have been set to 6 ns. A first curve 310 shows noise due to switching without delays. A second curve 320 shows the noise when applying the delays of 6 ns between respective subsequent power switches. In the example a daisy chain of delay units has been used. The resulting noise curve 320 is clearly improved with respect to the noise 310 without the delay units.

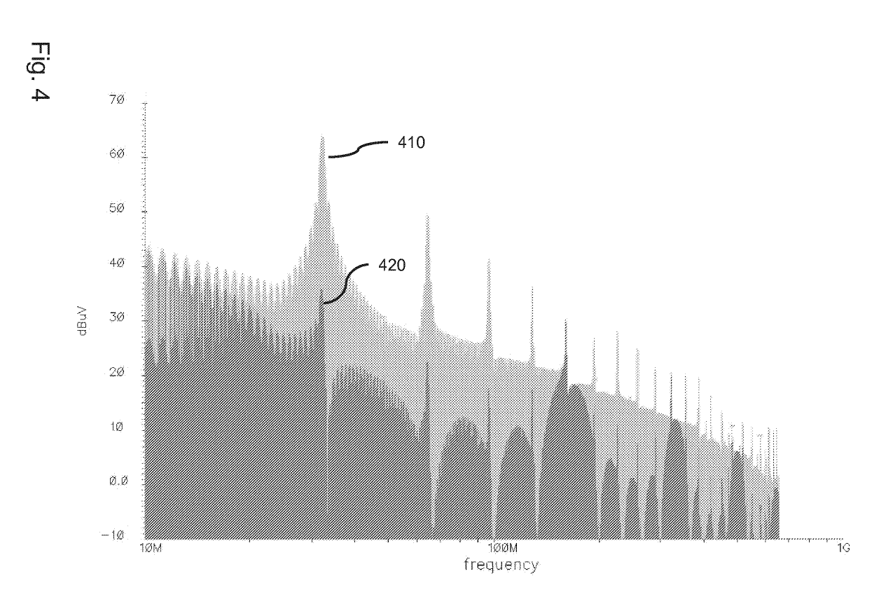

FIG. 4 shows a noise spectrum with and without delay units. In the Figure a graph shows the spectral intensity of the emissions in dBuV on the vertical axis, versus frequency (Hz) on the horizontal axis, both on logarithmic scale. In the example the delay units have been set to 6 ns. A first curve 410 shows spectrum due to switching without delays. A second curve 420 shows the spectrum when applying the delays of 6 ns between respective subsequent power switches. In the example a daisy chain of delay units has been used. The resulting spectrum 420 is clearly improved with respect to the spectrum 410 without the delay units.

Furthermore, the new architecture allows to reduce emission with increasing performance of charge pump circuitry, because efficiency of charge pumps is proportional to the power clock signal and the architecture enables the power clock signal to be equal to main clock signal.

The delay units are designed to provide a predetermined delay irrespective of temperature and process parameters of the circuit, e.g. implementing the device in an integrated circuit. Optionally the delay units may be current controlled delay units having a control current source for generating a control current for determining the predetermined delay.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device.

Furthermore, the units and circuits may be suitably combined in one or more semiconductor devices.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An electronic device for controlling multiple switching power circuits in a power supply system, each switching power circuit having a power clock for controlling switching of a supply side switch that enables charging, the device comprising respective power clock delay units, each respective power clock delay unit configured to provide a respective power clock at a predetermined delay based on a respective input clock, the respective predetermined delays being so that said switching of respective different supply side switches occurs at respective different points in time.

2. The device as claimed in claim 1, wherein the power clock delay units are coupled in series wherein the input clock of a respective power clock delay unit is coupled to the power clock of the preceding power clock delay unit.

3. The device as claimed in claim 1, wherein the delay unit is an analog delay cell.

4. The device of claim 3, wherein the analog delay cell comprises a control current source configured to a control current for determining the predetermined delay.

5. The device of claim 4, wherein the control current is predetermined during design of the device.

6. The device of claim 4, wherein the control current is adjustable via a control signal.

7. The device of claim 4, wherein respective control currents for respective analog delay cells are programmable.

8. The device of claim 4, wherein the device has a delay control input, and respective control currents for respective analog delay cells are arranged for being adjusted via the delay control input.

9. The device as claimed in claim 1, wherein the device comprises a digital control unit configured to control said multiple switching power circuits.

10. The device as claimed in claim 1, wherein the device comprises said multiple switching power circuits.

11. The device as claimed in claim 10, wherein each of the multiple switching power circuits has a respective data input configured to control the respective switching power circuit.

12. The device as claimed in claim 10, wherein the device comprises said multiple supply side switches coupled to said switching power circuits.

13. An integrated circuit comprising at least one electronic device according to claim 1.

14. In an electronic device ter configured to control multiple switching power circuits in a power supply system, each switching power circuit having a power clock for controlling switching of a supply side switch that enables charging, a method comprises providing respective power clock delays to the switching power circuits, each respective power clock delay providing a respective power clock at a predetermined delay based on a respective input clock, the respective predetermined delays being so that said switching of respective different supply side switches occurs at respective different points in time.

15. The method of claim 14, wherein providing the delay comprises controlling a current source for generating a control current for determining the predetermined delay.

16. The method of claim 15, wherein the method comprises predetermining the control current during design of the device.

17. The method of claim 15, wherein the method comprises adjusting the control current via a control signal.

18. The method of claim 15, wherein the method comprises programming the respective control currents for respective delays.
